(19) United States
(12) Patent Application Publication
(10) Pub. No.: US 2014/0233456 A1
(43) Pub. Date: Aug. 21, 2014

(54) COMMUNICATION DEVICE, COMMUNICATION METHOD, STORAGE MEDIUM, AND COMMUNICATION SYSTEM

(71) Applicant: FUJITSU LIMITED, Kawasaki-shi (JP)

(72) Inventor: Takeshi Kodama, Yokohama (JP)

(73) Assignee: FUJITSU LIMITED, Kawasaki-shi (JP)

(21) Appl. No.: 14/170,683

(22) Filed: Feb. 3, 2014

(30) Foreign Application Priority Data
Feb. 21, 2013 (JP) 2013-032638

(51) Int. Cl. H04L 1/18; H04L 12/26

(52) U.S. Cl. CPC H04L 1/188; H04L 43/0835; H04L 43/0864
USPC 370/328

(57) ABSTRACT

A communication device includes a memory, and a processor coupled to the memory and configured to execute a process, the process including setting a retransmission determination time for a packet complying with a protocol of a first layer based on a communication state of a second layer that is lower than the first layer.

### CROSS-REFERENCE TO RELATED APPLICATION

This application is based upon and claims the benefit of priority from the prior Japanese Patent Application No. 2013-032638, filed on Feb. 21, 2013, the entire contents of which are incorporated herein by reference.

### FIELD

The embodiment discussed herein is related to a communication device, a communication method, a storage medium, and a communication system.

### BACKGROUND

In a communication device performing communication in accordance with the transmission control protocol (TCP), a round trip time (RTT) value is measured which represents a time from transmission of a packet to reception of a receipt acknowledgement for the relevant packet. A retransmission time out (RTO) value, that is, a retransmission determination time to determine retransmission of a packet, is decided based on the measured RTT value. There are various algorithms for deciding the RTO value. In general, the RTO value is decided, for example, based on an average deviation of the RTT values such that the RTO value is not abruptly changed with a change of the RTT value.

When a receipt acknowledgement is not received even after exceeding the retransmission determination time from the transmission of a packet, the above-mentioned communication device determines that a packet loss has generated in a network. The communication device retransmits the packet for which the receipt acknowledgement has not been received, and further lowers a transmission rate such that a packet loss will not generate again. If the RTT value measured thereafter reduces, the transmission rate is gradually increased.

There is known a technique of, when a retransmission timer value exceeds a threshold set based on a propagation delay, updating the retransmission timer value by multiplying the set retransmission timer value by a certain attenuation coefficient (see Japanese Laid-open Patent Publication No. 2008-219408). There is also known a technique of determining whether the set RTO value is exceeded with spurious timeout, by transmitting a test packet for measurement (see P. Sarolahti, other threes, “Forward RTO-Recovery (F-RTO): An Algorithm for Detecting Spurious Retransmission Timeouts with TCP”, RFC5682, September 2009.)

### SUMMARY

According to an aspect of the invention, a communication device includes a memory, and a processor coupled to the memory and configured to execute a process, the process including setting a retransmission determination time for a packet complying with a protocol of a first layer based on a communication state of a second layer that is lower than the first layer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a communication system according to an embodiment and an example of communication;

FIG. 2 illustrates an example of a communication system according to an embodiment and another example of communication;

FIG. 3 illustrates an example of changes over time in relation among an radio-wave quality value, an RTO value, and an RTT value;

FIG. 4 illustrates an example of changes over time in a transfer rate;

FIG. 5 illustrates an example of changes over time in a transfer rate when a process according to an embodiment is executed;

FIG. 6 illustrates an example of a hardware configuration according to the embodiment;

FIG. 7 illustrates an example of a functional block diagram according to the embodiment;

FIG. 8 illustrates an example of information used in processes executed in EXAMPLE 1;

FIG. 9 illustrates an example of the processes executed in EXAMPLE 1;

FIG. 10 illustrates an example of information used in processes executed in EXAMPLE 2;

FIG. 11 illustrates an example of the processes executed in EXAMPLE 2;

FIGS. 12A, 12B, and 12C illustrate an example of information used in processes executed in EXAMPLE 3;

FIG. 13 illustrates an example of the processes executed in EXAMPLE 3;

FIG. 14 illustrates an example of processes executed in EXAMPLE 4;

FIG. 15 illustrates an example of processes executed in EXAMPLE 5;

FIG. 16 illustrates an example of processes executed in EXAMPLE 6;

FIG. 17 illustrates an example of processes executed in EXAMPLE 7; and

FIG. 18 illustrates an example of processes executed in EXAMPLE 8.

### DESCRIPTION OF EMBODIMENTS

With studies conducted by the inventor, unless a retransmission determination time for a packet is set depending on communication environments, the packet is transmitted at a transmission rate not adapted for the communication environments, and communication efficiency is reduced in some cases.

According to embodiments described below, the packet retransmission determination time in an upper-level communication layer is set depending on the communication environments by employing information representing a communication state of a lower-level communication layer.

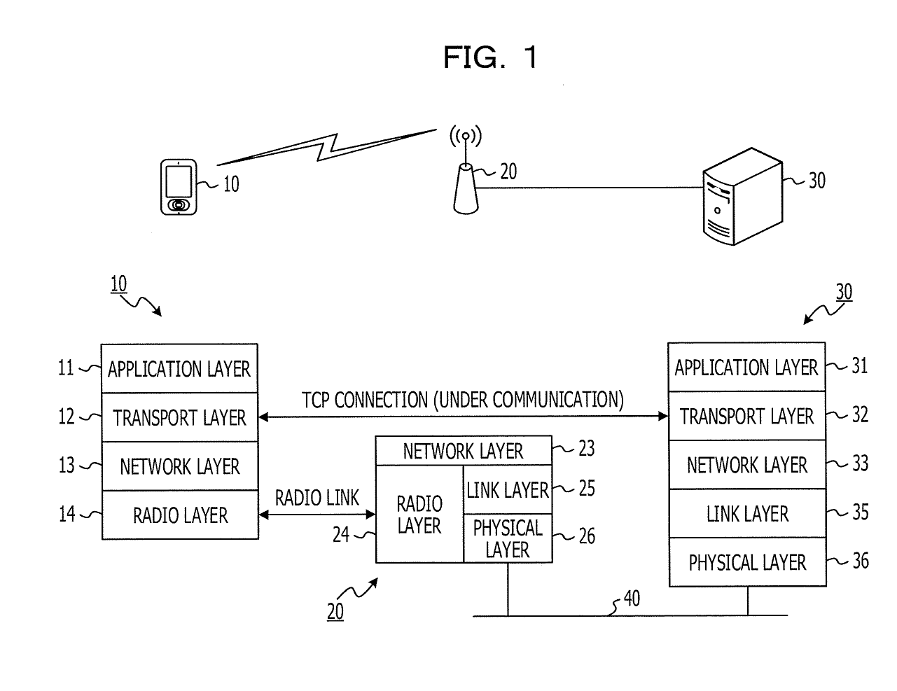

FIG. 1 illustrates an example of a communication system according to an embodiment and an example of communication. The communication system according to the embodiment includes a mobile communication terminal 10, a base station 20, and a server 30. The mobile communication terminal 10 is classified, from the viewpoint of communication function and circuit, into an application layer 11, a transport layer 12, a network layer 13, and a radio layer 14. The base station 20 is classified, from the viewpoint of communication function and circuit, into a network layer 23, a radio layer 24, a link layer 25, and a physical layer 26. The server 30 is classified, from the viewpoint of communication function and circuit, into an application layer 31, a transport layer 32, a network layer 33, a link layer 35, and a physical layer 36. It is to be noted that, in the description of the embodiment, other layers than mentioned above, such as a presentation layer and a cession layer, in each of the mobile communication terminal 10 and the server 30 are omitted, and the layers used for the description are mentioned.

In data communication between the mobile communication terminal 10 and the server 30, a packet transmitted from the mobile communication terminal 10 via the radio link is relayed by the base station 20, and the packet is delivered from the base station 20 to the server 30 via a wired network 40. On the other hand, data communication from the server 30 to the mobile communication terminal 10 is also executed by the base station 20 that relays a packet.

More specifically, when there is a request from the application layer 11 of the mobile communication terminal 10, data corresponding to the request is processed into the form of a packet in the transport layer 12 in accordance with the TCP protocol, for example. In the network layer 13, the data is further processed into the form of a packet in accordance with an Internet protocol (IP) address, for example. The packet is then transmitted from the radio layer 14 to the radio link. The transmitted packet is received by the radio layer 24 of the base station 20. The packet received by the base station 20 is transmitted from the physical layer 26 of the base station 20 to the physical layer 36 of the server 30 via the wired network 40, and is then processed by the application layer 31. The server 30 transmits a reply to the request from the mobile communication terminal 10 back to the mobile communication terminal 10 in a route that is reverse to the above-mentioned route.

The embodiment is described in connection with the case using the TCP, which is one example of the protocol employed in the transport layers 12 and 32, but the embodiment is not limited to that case. In packet communication in accordance with the TCP protocol, reliability of the packet communication is ensured by the receiving side transmitting a receipt acknowledgment to the transmitting side in replay to the transmitted packet. In data communication between the mobile communication terminal 10 and the server 30, for example, a receipt acknowledgment to a packet transmitted from the mobile communication terminal 10 is transmitted from the server 30 to the mobile communication terminal 10.

The transport layer 12 of the mobile communication terminal 10 measures a time from the transmission of the packet to the reception of the receipt acknowledgment. The measured time is a round trip time (RTT) value. Furthermore, the transport layer 12 calculates a retransmission time out (RTO) value that is determined depending on the RTT values having been measured for each of the packet transmissions in the past. Instead of being updated depending on the latest RTT value, the RTO value may be calculated to moderately change with a change of the RTT value by employing a weighted average and an average deviation of the RTT values and so on, which have been measured in the past.

The transport layer 12 sets the above-mentioned RTO value as a retransmission determination time for a packet. If the transport layer 12 does not receive the receipt acknowledgment after reaching the RTO value from the transmission of the packet, it determines that the packet has been lost somewhere in the communication system, and then retransmits the packet. In addition to retransmitting the packet, the transport layer 12 reduces a transmission rate. The reason is as follows. If the packet is retransmitted at the same transmission rate in spite of retransmitting the packet in response to the determination that a packet loss has generated, there is a high possibility that the packet may be similarly lost again. It is to be noted that, when time periods until receiving the receipt acknowledgment for packets transmitted thereafter become shorter, the transmission rate is restored to gradually increase depending on the RTT value that becomes smaller corresponding to changes of the time periods, and the RTO value is also gradually updated to a smaller value.

While the embodiment is described in connection with the communication system illustrated in FIG. 1, the embodiment is not limited to the configuration illustrated in FIG. 1, and the data communication may be performed as radio communication between the base station 20 and the server 30. In addition, the server 30 may be a mobile communication terminal. Thus, the mobile communication terminal 10 and the server 30 are examples of the communication device.

The embodiment is applicable to a communication system that includes, in a part of a communication path where a protocol determining the packet retransmission determination time by receiving the receipt acknowledgement for the transmitted packet, a communication path of radio communication where the communication state is maintained even in a period during which no packets are transmitted and received in accordance with that protocol. In one example of such a communication system, the system includes TCP connection as a communication path for transmitting and receiving packets in accordance with the TCP protocol, and communication is performed via a radio link in at least a part of the TCP connection.

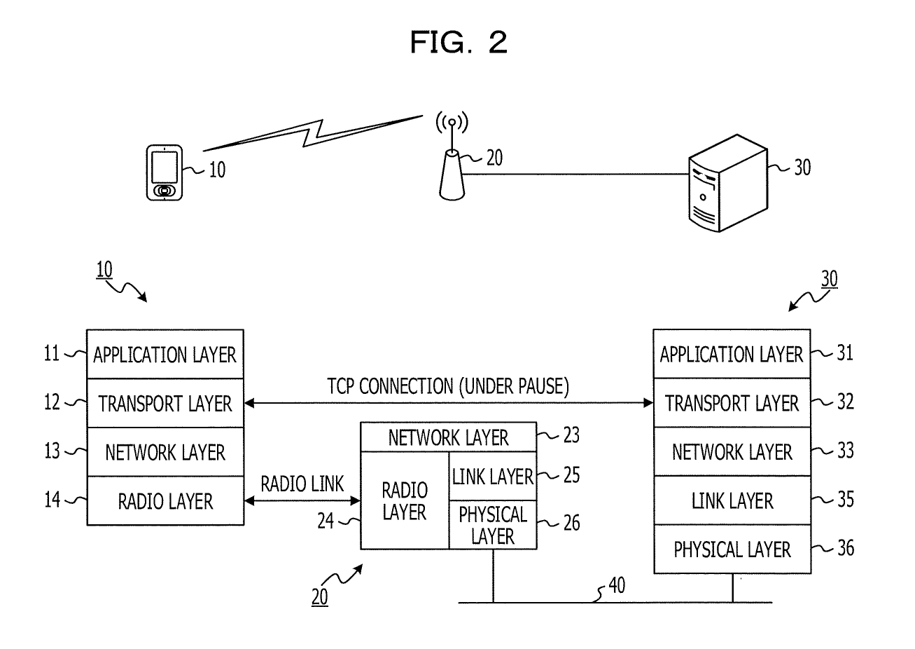

FIG. 2 illustrates an example of a communication system according to an embodiment and another example of communication. The communication system illustrated in FIG. 2 has the same configuration as that illustrated in FIG. 1, but it differs from FIG. 1 in that the packet communication in accordance with the TCP protocol is paused while the TCP connection is maintained in the communication between the mobile communication terminal 10 and the server 30 without being opened.

Even during a period in which the packet communication in accordance with the TCP protocol is paused, however, a control message for synchronization, and so on are periodically transmitted from the base station 20 to the mobile communication terminal 10 such that the radio communication is to be maintained between the mobile communication terminal 10 and the base station 20. The mobile communication terminal 10 having received the control message notifies, to the base station 20, a carrier to interface and noise ratio (CINR) value that represents radio-wave quality based on electric power of a radio signal. To continuously maintain the radio communication, the base station 20 may instruct change of the modulation method and the code rate to the mobile communication terminal 10 in accordance with the received CINR value. In other words, even during the period in which the packet communication in accordance with the TCP protocol is paused, the radio link between the mobile communication terminal 10 and the base station 20 is maintained. When the packet communication in accordance with the TCP protocol is restarted, the communication is executed in accordance with the modulation method and the code rate, which are instructed from the base station 20.

Accordingly, even during the period in which the packet communication in accordance with the TCP protocol is paused, the radio-wave quality may be measured in the radio layer of each of the mobile communication terminal 10 and the base station 20.

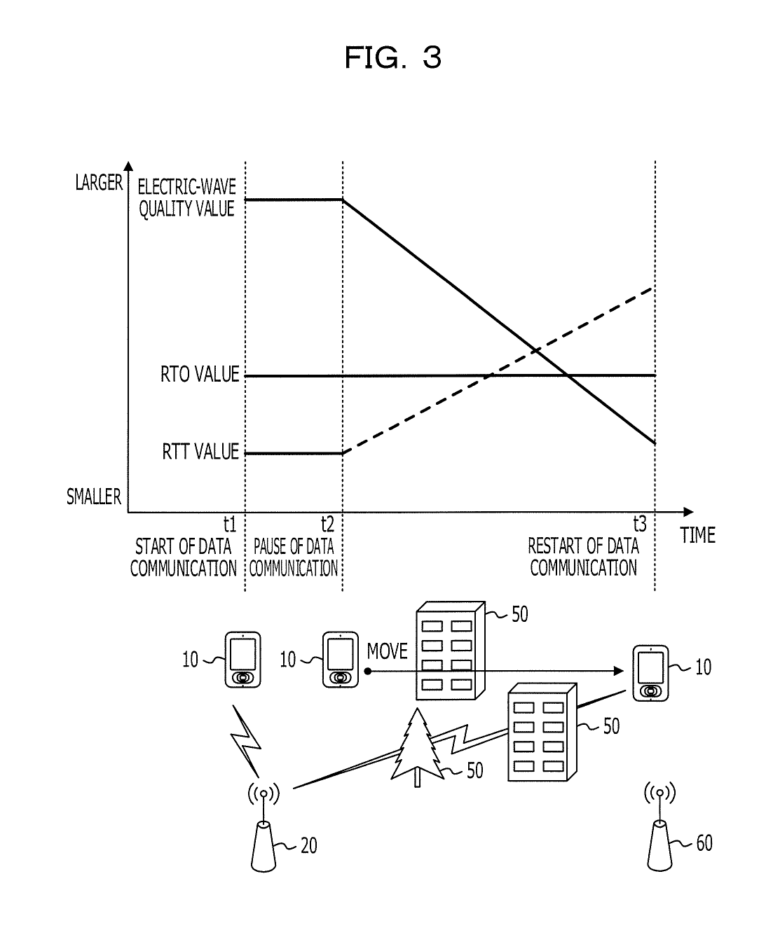

FIG. 3 illustrates an example of changes over time in relation among the radio-wave quality value, the RTO value, and the RTT value. The example of changes over time, illustrated in FIG. 3, represents the case where the mobile communication terminal 10 starts data communication with the server 30 (not illustrated) via the base station 20 at time t1 and pauses the data communication at time t2. After reaching time t3 while a radio link with the base station 20 is maintained without making the TCP connection to the server 30 opened, the mobile communication terminal 10 restarts the data communication with the server 30 at time t3. It is here assumed that the mobile communication terminal 10 moves in a period from the time t2 to t3, and that because obstacles 50 come to interpose between the mobile communication terminal 10 and the base station 20 with the movement of the mobile communication terminal 10, the radio-wave quality of the radio link between the mobile communication terminal 10 and the base station 20 degrades due to the obstacles 50 and interference waves.

As illustrated in a graph of FIG. 3, it is assumed that the radio-wave quality between the mobile communication terminal 10 and the base station 20 is not changed in a period from the time t1 to t2. In such a case, unless communication environments between the base station 20 and the server 30 are changed, the packet communication is executed continuously in a state where the RTT value corresponding to a time from transmission of a packet from the mobile communication terminal 10 to reception of a receipt acknowledgment is not changed. Since the RTT value is not changed, the RTO value calculated depending on the RTT value is also not changed.

During the period from the time t2 to t3, as described above, the mobile communication terminal 10 moves and the radio-wave quality gradually degrades due to the interposition of the obstacles 50 and so on. During the period from the time t2 to t3, however, the mobile communication terminal 10 pauses the packet communication in accordance with the TCP protocol between itself and the server 30, and the RTT value is not measured because of the pause of the packet communication. Accordingly, the RTO value is held at the same value as that taken when the data communication was paused.

An increase of the RTT value denoted by a dotted line in the graph of FIG. 3 represents a value that is not actually measured because of the pause of the packet communication. The dotted line illustrates, as an example, that if the RTT value is measured during the above-mentioned period, the number of times of retransmission processes in the radio layer is increased with gradual degradation of the radio-wave quality, and the time until receiving the receipt acknowledgement for the transmitted packet is prolonged, whereby the RTT value increases.

Stated in another way, at the time t3 when the data communication is restarted, in spite of that, in fact, the radio-wave quality degrades and the RTT value corresponding to the radio-wave quality increases, the retransmission determination after the restart of the communication is executed based on the RTO value, which has not been updated from the time t2 to t3 because of the pause of the packet communication. In such a case, the time until receiving the receipt acknowledgement is prolonged due to the degradation of the radio-wave quality, and the receipt acknowledgement is not received even after reaching the RTO value. Thus, even when the receipt acknowledgement is received by waiting longer in spite of the degradation of the radio-wave quality, the packet is retransmitted because of the RTO value being not adapted for the radio-wave quality, and control of lowering the transmission rate is further executed.

In mobile communication, for example, a possibility of change in the radio-wave quality is relatively high, and the influence upon change of the RTT value in the communication system is relatively large. Furthermore, the radio-wave quality may change when a handover process is executed with the movement of the mobile communication terminal 10 and the communication is switched over to radio communication with a base station 60. In such a case, retransmission of the packet and control of the transmission rate are executed based on the RTO value not adapted for the radio-wave quality.

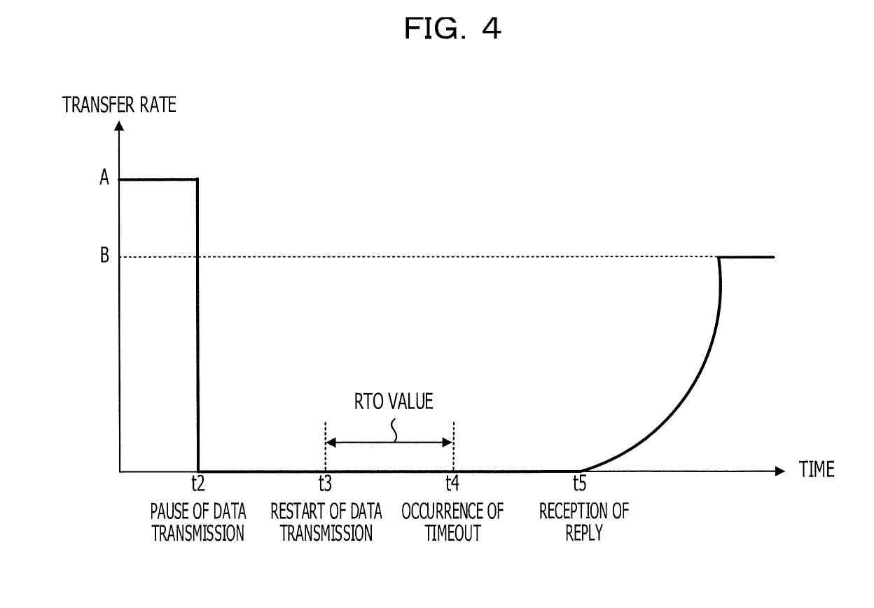

FIG. 4 illustrates an example of changes over time in a transfer rate. Time t2 and t3 illustrated in FIG. 4 correspond respectively to the time t2 and t3 illustrated in FIG. 3. Until the time t2, the data transmission is executed at a value of the transfer rate denoted by A, and at the time t2, the data transmission is paused. At the time t3, the data communication is restarted based on the RTO value held when the data communication was paused at the time t2. It is to be noted that FIG. 4 illustrates changes over time in the transfer rate of the packet for which the receipt acknowledgement has been received.

As discussed above, because the radio-wave quality degrades during the period from the time t2 to t3, the retransmission determination is executed based on a relatively small RTO value in terms of proportion to the degraded radio-wave quality. Accordingly, the receipt acknowledgement for the transmitted packet arrives after reaching the RTO value. In other words, since the receipt acknowledgement does not arrive even after waiting for a period determined corresponding to the RTO value, a timeout of the RTO value occurs at time t4, and the receipt acknowledgement is received at time t5 after the time t4.

If the timeout occurs at the time t4, the mobile communication terminal 10 determines that a packet loss has generated in the network. Then, the mobile communication terminal 10 executes packet retransmission control and lowers the packet transmission rate such that the packet loss will not generate again. In other words, in spite of being able to receive the receipt acknowledgement by waiting longer, the packet transmission rate is lowered at the time t4 for the reason that the receipt acknowledgement has not arrived even after waiting for a time, which was determined based on the RTO value before the degradation of the radio-wave quality.

Thereafter, the mobile communication terminal 10 begins to receive the receipt acknowledgement at the time t5. However, the transmission rate having lowered so far is gradually increased up to the transmission rate adapted for the radio-wave quality, denoted by B, through a process in which the RTT value is successively measured while confirming the reception of the receipt acknowledgement. Stated in another way, after the restart of the communication, communication efficiency deteriorates in a restoration time until the transmission rate is increased to an adapted value, because the transmission rate is lowered as a result of determining the retransmission based on the RTO value that was held before the degradation of the radio-wave quality.

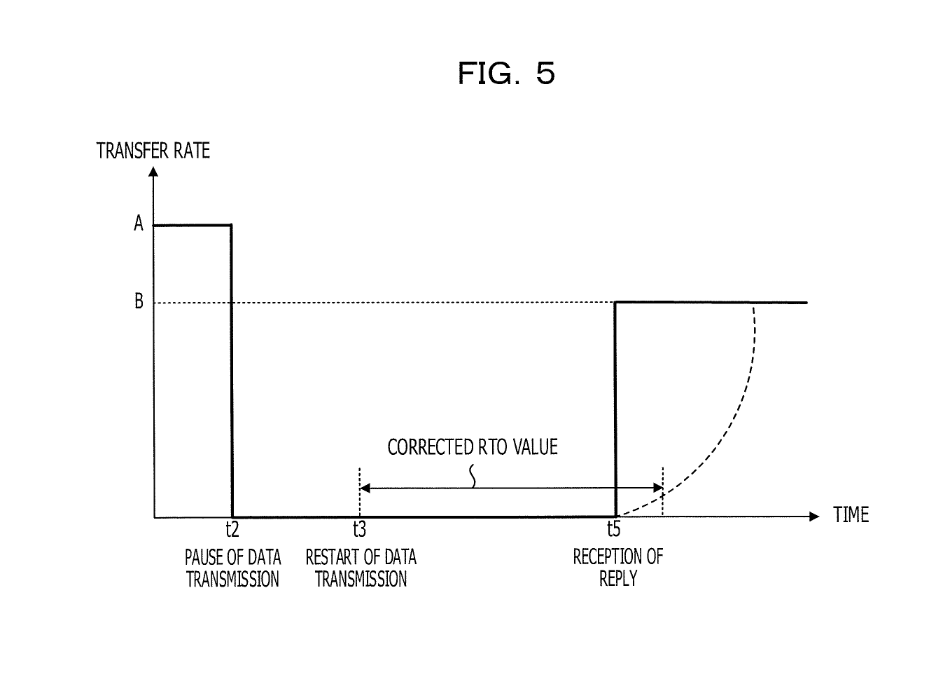

FIG. 5 illustrates an example of changes over time in the transfer rate when a process according to an embodiment is executed. According to the embodiment described below, for example, even when calculation of the RTO value corresponding to the measured RTT value is not performed during a pause period of the communication in accordance with the TCP protocol for the reason that the packet communication accompanying the measurement of the RTT value is not performed during the pause period of the TCP protocol communication, the retransmission determination time to determine retransmission of the packet is updated by considering the radio communication maintained during the pause period and by employing information related to the radio-wave quality, the information being acquired by the radio layer. In other words, even if the packet communication in accordance with the protocol in an upper-level communication layer is paused, the retransmission determination time of a packet in accordance with the protocol in the upper-level communication layer is updated by employing information representing the communication state of a lower-level communication layer. Accordingly, even when the radio-wave quality has changed during a pause period of the packet transmission in accordance with the protocol in the upper-level communication layer, the communication is restarted with the retransmission determination time adapted for the changed radio-wave quality. Moreover, according to the embodiment, a measurement test packet for measuring the RTT value after restart of the communication may not be transmitted. Hence wasteful use of a network band is avoided which may be resulted by transmitting the measurement test packets whenever many mobile communication terminals restart communications, even though the data size of each measurement test packet is small. In the following embodiment, the RTO value set using the communication state information is called a “corrected RTO value”.

As illustrated in FIG. 5, for example, the corrected RTO value is set to be larger corresponding to the degradation of the radio-wave quality than the RTO value before the pause of the communication. Unlike the example illustrated in FIG. 4, counting of the RTO value ends at time later than the time t5 of receiving the receipt acknowledgement. Accordingly, the control of lowering the transfer rate is not executed before receiving the receipt acknowledgement, and the transfer rate at the time t5 is set to the value denoted by B. Thus, the transfer rate is quickly increased to the value B, and communication efficiency after the restart of the communication is improved in comparison with the example of FIG. 4 in which the transfer rate is increased to gradually approach the value B.

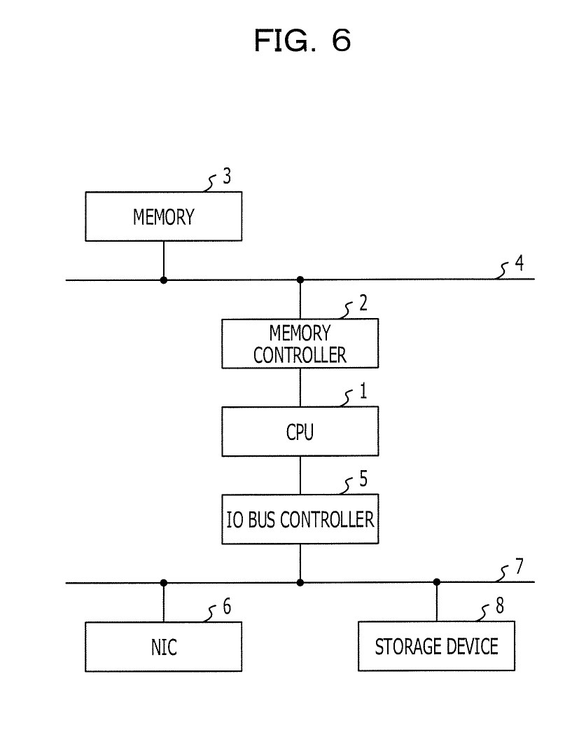

FIG. 6 illustrates an example of a hardware configuration according to the embodiment. The mobile communication terminal 10 serving as a transmitter, according to the embodiment, includes a central processing unit (CPU) 1, a memory controller 2, a memory 3, a memory bus 4, an input/output (IO) bus controller 5, a network interface card (NIC) 6, and an IO bus 7. A storage device 8 is connected to the IO bus 7.

The memory 3 connected to the memory bus 4 stores programs to execute various processes in the mobile communication terminal 10 according to the embodiment. The CPU 1 reads out the programs from the memory 3 via the memory controller 2 and executes the various processes. With the progress of the various processes executed by the CPU 1, write and read of data into and from the memory 3 are executed via the memory controller 2.

Via the IO bus controller 5, the CPU 1 transfers data to the NIC 6, which is connected to the IO bus 7, and receives data and packets from the NIC 6. Via the IO bus controller 5, the CPU 1 reads data from the storage device 8, which is connected to the IO bus 7, and writes data into the storage device 8.

The CPU 1 may include one or more CPU cores to execute the various processes. Each CPU core may include one or more processors. The memory 3 is a random access memory (RAM), such as a dynamic random access memory (DRAM). The storage device 8 is, for example, a nonvolatile memory such as a read only memory (ROM) or a flash memory, or a magnetic disk device such as a hard disk drive (HDD).

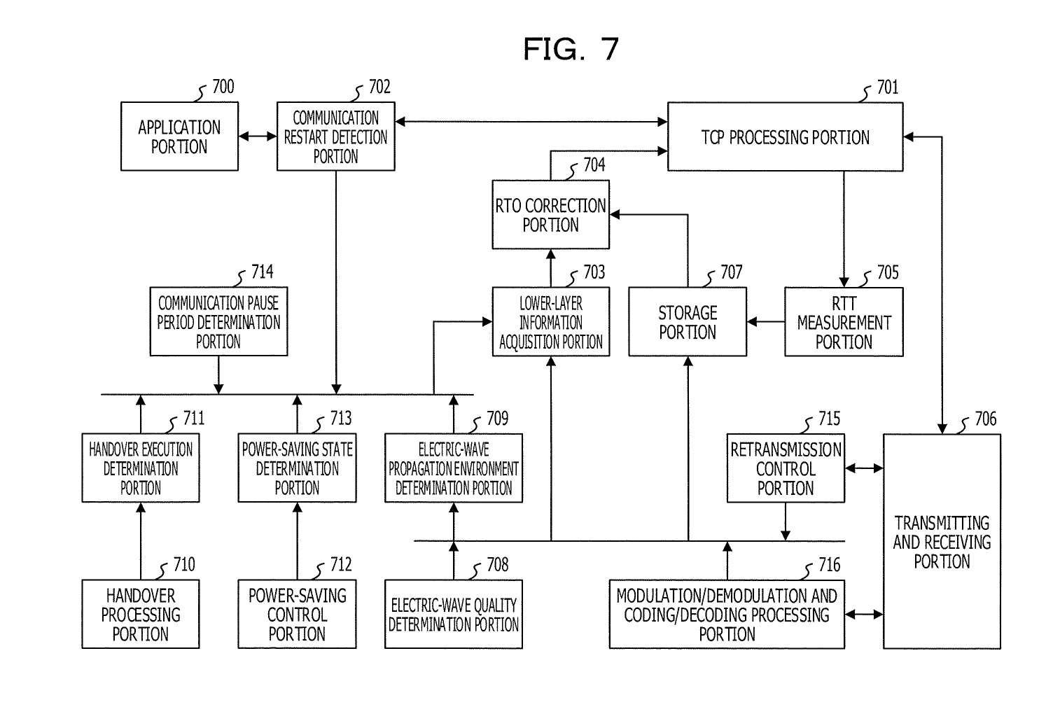

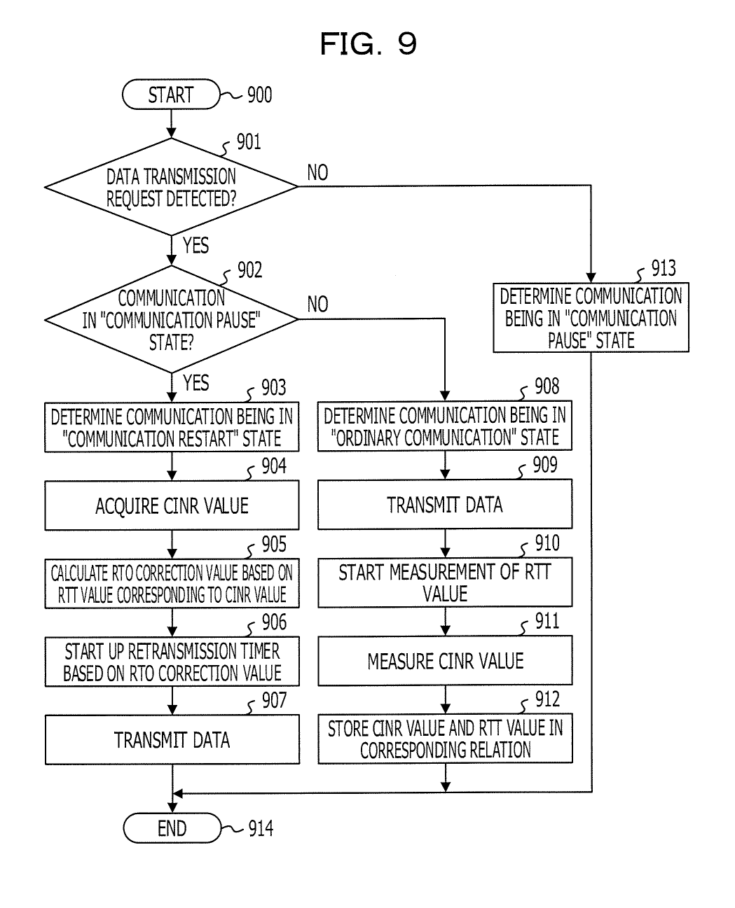

Another configuration that the CPU 1, the memory controller 2, the memory 3, the NIC 6, and the storage device 8 are connected to the same bus may be applied to the mobile communication terminal 10 according to the embodiment. Functional blocks illustrated in FIG. 7 are realized and processes illustrated in FIGS. 9, 11, 13, 14, 15, 16, 17 and 18 are executed with the hardware configuration illustrated in FIG. 6.

FIG. 7 illustrates an example of a functional block diagram according to the embodiment. An application portion 700 communicates data at an application level with a communication partner (receiver) in accordance with the TCP.

A TCP processing portion 701 executes packet processing in accordance with the TCP, and processes transmission data into a transmitted packet.

A communication restart detection portion 702 detects restart of data communication by the mobile communication terminal 10 (transmitter) that has been the pause state of the data communication. For example, the communication restart detection portion 702 detects that the mobile communication terminal 10 in the state where packet communication in accordance with the TCP was paused while the TCP connection was not opened, has restarted the packet communication from the pause state.

In more detail, the communication restart detection portion 702 monitors the presence or the absence of a data transmission request issued from the application portion 700 to the TCP processing portion 701, and determines that the TCP communication is in a “communication pause” state if the data transmission request has not been detected. If the data transmission request issued from the application portion 700 to the TCP processing portion 701 is detected in the “communication pause” state, the communication restart detection portion 702 determines that the TCP communication is in a “communication restart” state. Furthermore, when the communication restart detection portion 702 determines the “communication pause” state or the “communication restart” state, it notifies the pause or the restart of the data communication to a lower-layer information acquisition portion 703, an radio-wave propagation environment determination portion 709, a handover execution determination portion 711, and a communication pause period determination portion 714.

The embodiment is described, for example, in connection with the TCP communication for the convenience of explanation, the embodiment is not limited to the following one. The embodiment is applicable to various types of communications insofar as the communication is performed in accordance with the protocol in which the retransmission determination time is set based on the presence of the packet communication, for example, in which the time from the transmission of a packet to the reception of the receipt acknowledgement for the packet is utilized to set the retransmission determination time.

When the restart of the data communication is notified from the communication restart detection portion 702, the lower-layer information acquisition portion 703 acquires information regarding the state of radio communication from a radio layer that is a lower-level layer. For example, the lower-layer information acquisition portion 703 acquires information, which is used for correcting the RTO value, from the radio layer upon receiving the notification of “communication restart” from the communication restart detection portion 702.

The information acquired from the radio layer contains the CINR value representing the radio-wave quality at the time when the notification of “communication restart” is notified from the communication restart detection portion 702, the modulation method, the code rate, and the maximum number of times of retransmission processes in automatic repeat-request (ARQ)/hybrid automatic repeat-request (HARQ). At the time when the notification of “communication restart” is notified from the communication restart detection portion 702, the result of determination as to whether the handover is under execution and the result of determination as to whether the radio layer is in a power saving state may also be acquired as other examples of the above-mentioned information. Those information items correspond to information regarding the radio-wave quality of a second-layer signal between the mobile communication terminal and the base station, and represent information of a communication state of the second layer.

Moreover, upon receiving the notification from the communication restart detection portion 702, the lower-layer information acquisition portion 703 may acquire at least one of respective determination results of the radio-wave propagation environment determination portion 709, the handover execution determination portion 711, the communication pause period determination portion 714, and a power-saving state determination portion 713, and then determine based on the acquired determination result whether the information of the radio layer is to be acquired.

An RTO correction portion 704 corrects the RTO value based on the information acquired by the lower-layer information acquisition portion 703 from the radio layer and the relevant information stored in a storage portion 707.

An RTT measurement portion 705 measures the RTT value representing the time from the transmission of a packet to the reception of an acknowledgement (ACK) packet that is transmitted by the communication partner for receipt confirmation in reply to the transmitted packet.

A transmitting and receiving portion 706 transmits a transmission packet processed into the form of a radio signal to a radio base station, and receives a packet in the form of a radiosignal, which has been transmitted from the radio base station.

The storage portion 707 stores, depending on necessity in applications, information indicating correlation between the CINR value representing the radio-wave quality and the RTT value, information indicating correlation between the CINR value representing the radio-wave quality and the number of times of retransmissions in the ARQ/HARQ, information indicating correlation between each of the CINR value representing the radio-wave quality, the modulation method, and the code rate and the retransmission incidence in the lower-level layer, and a minimum one of the RTT values having been measured from the time of establishment of the TCP connection, those items being described later.

An radio-wave quality measurement portion 708 measures the radio-wave quality based on a signal transmitted from the radio base station. The radio-wave quality measurement portion 708 measures, for example, the CINR value representing the radio-wave quality.

The radio-wave propagation environment determination portion 709 determines whether the radio-wave quality of radio communication with the radio base station has changed during the pause period of the TCP communication. The radio-wave propagation environment determination portion 709 determines, for example, whether the radio-wave quality has degraded beyond a certain level. As described above, the start of the pause period of the TCP communication, the pause state, the restart of the TCP communication, and so on are notified from the communication restart detection portion 702.

A handover processing portion 710 executes changeover of the radio base station with which the mobile communication terminal 10 communicates.

The handover execution determination portion 711 determines whether the handover has been made during the pause period of the TCP communication. For example, upon receiving the notification of “communication pause state” from the communication restart detection portion 702, the handover execution determination portion 711 starts monitoring of the handover process executed by the handover processing portion 710, and pauses the monitoring upon receiving the notification of “communication restart”. When the handover process is executed during the monitoring period, the handover execution determination portion 711 determines that “the handover has been made”.

A power-saving control portion 712 controls supply and pause of electric power with respect to communication circuits, such as the NIC 6, for realizing the radio layer function.

The power-saving state determination portion 713 determines, when restarting the TCP communication, whether the electric power is supplied to the communication circuits for realizing the radio layer function. For example, upon receiving the notification of “communication restart” from the communication restart detection portion 702, the power-saving state determination portion 713 determines whether the electric power is supplied to the communication circuits such as the NIC 6.

The communication pause period determination portion 714 measures a lapsed time of the pause period of the TCP communication and determines whether the lapsed time is not shorter than a certain time. More specifically, the communication pause period determination portion 714 measures the lapsed time by a timer, and makes the determination by comparing the measured lapsed time with the set certain time.

A retransmission control portion 715 executes a data retransmission process in the ARQ/HARQ.

A modulation/demodulation and coding/decoding processing portion 716 executes coding and decoding of the transmission packet in accordance with the coding method that is notified from the radio base station to be employed at that time. Furthermore, the modulation/demodulation and coding/decoding processing portion 716 executes modulation and demodulation of the transmission packet in accordance with the code rate that is notified from the radio base station to be employed at that time. In addition, the modulation/demodulation and coding/decoding processing portion 716 notifies the modulation method and the code rate, which are employed at that time, in response to a request from the lower-layer information acquisition portion 703.

The application portion 700, the TCP processing portion 701, the communication restart detection portion 702, the lower-layer information acquisition portion 703, the RTO correction portion 704, the RTT measurement portion 705, the radio-wave quality measurement portion 708, the radio-wave propagation environment determination portion 709, the handover processing portion 710, the handover execution determination portion 711, the power-saving control portion 712, the power-saving state determination portion 713, the communication pause period determination portion 714, the retransmission control portion 715, and the modulation/demodulation and coding/decoding processing portion 716 are realized with the CPU 1, illustrated in FIG. 6, loading and executing the programs stored in the memory 3. The storage portion 707 is realized with the memory 3 and the storage device 8. The transmitting and receiving portion 706 is realized with the NIC 6.

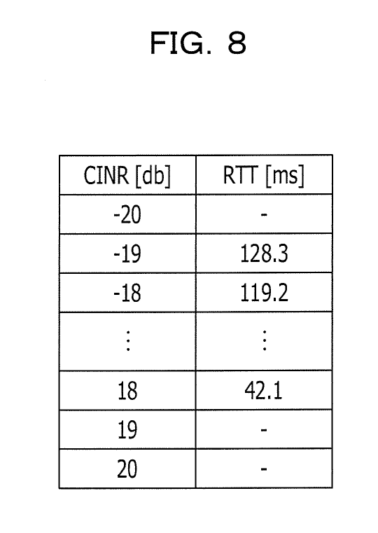

EXAMPLE 1 will be described below with reference to FIGS. 8 and 9. EXAMPLE 1 represents an embodiment in which, to increase the communication efficiency after the restart of the TCP communication, the retransmission determination time adapted for a change in the radio-wave quality is set by indirectly obtaining the RTT value corresponding to the CINR value, measured when restarting the communication, based on the correlation between the RTT value and the CINR value both having being measured during an execution period of the TCP communication.

FIG. 8 illustrates an example of information used in processes executed in EXAMPLE 1. The information illustrated in FIG. 8 is information representing correspondence between the CINR value, which is one example of information related to the radio-wave quality of signals transmitted and received between the respective radio layers 14 and 24 in the mobile communication terminal 10 and the base station 20, and the RTT value in the TCP communication between the respective transport layers 12 and 32. That information is stored in the memory 3 illustrated in FIG. 6, that is, the storage portion 707 in FIG. 7.

The storage portion 707 stores information representing, in corresponding relation, the RTT value and the CINR value that have been measured respectively by the RTT measurement portion 705 and the radio-wave quality measurement portion 708 from the start of the data communication by the application portion 700. The information stored in the storage portion 707 is obtained by the RTO correction portion 704 in a process 905 (described below) in FIG. 9.

As illustrated in FIG. 8, the stored information indicates, for example, such correspondence that when the CINR value is “−18” [db], the RTT value is “119.2” [ms]. When the RTT value corresponding to the measured CINR value is already stored, a weighted average value of the RTT value corresponding to the measured CINR value and the already-stored RTT value may be used. Alternatively, the RTT value corresponding to the measured CINR value may be used as it is.

FIG. 9 illustrates an example of the process executed in EXAMPLE 1.

The communication restart detection portion 702 executes a process 901 of determining whether the data transmission request has been detected. In the process 901, the communication restart detection portion 702 detects, for example, the data transmission request by monitoring the data transmission request issued from the application portion 700. If the communication restart detection portion 702 determines that the data transmission request is not detected, it executes a process 913 of determining that the communication is in the “communication pause” state, and then shift to a process 914. On the other hand, if the communication restart detection portion 702 determines in the process 901 that the data transmission request has been detected, it shifts to a process 902.

The communication restart detection portion 702 executes a process 902 of determining whether the communication is in the “communication pause” state. Because the process 902 is executed after the data transmission request has been detected in the process 901, the determination in the process 902 that the communication is in the “communication pause” state, for example, implies that the application portion 700 of a communication device under the communication state of “communication pause” is issuing the data transmission request, and that the communication is restarted thereafter. In such a case, the communication restart detection portion 702 determines in a process 903 that the communication is to be in the “communication restart” state, and then brings the communication into the “communication restart” state. On the other hand, the determination in the process 902 that the communication is not in the “communication pause” state implies that the application portion 700 of the communication device under the communication state of “ordinary communication” is issuing the data transmission request. In such a case, the communication restart detection portion 702 determines in a process 908 that the communication is to be in the “ordinary communication” state, and then brings the communication into the “ordinary communication” state.

If it is determined that the communication is in the “communication restart” state, the lower-layer information acquisition portion 703 executes a process 904 of acquiring the CINR value. In the process 904, the lower-layer information acquisition portion 703 acquires the CINR value representing the radio-wave quality measured by the radio-wave quality measurement portion 708.

The CINR value acquired in the process 904 is the CINR value at the time when it is determined that the communication is in the “communication restart” state. Regardless of whether the communication is in the “communication pause” state or the “ordinary communication” state, radio communication is continued by the radio layers 14 and 24 to maintain the radio communication between the mobile communication terminal 10 and the base station 20, and the CINR value is measured by the radio-wave quality measurement portion 708 based on the electric power of a radio signal in that radio communication.

In more detail, to maintain the radio communication, the base station 20 periodically transmits, for example, a control message to the mobile communication terminal 10. The mobile communication terminal 10 measures signal power of the control message and calculates a ratio of the measured signal power to interference waves and noise, thus setting the ratio as the CINR value. The set CINR value is, as described above, stored in the storage portion 707 in corresponding relation to the RTT value at that time.

The RTO correction portion 704 executes a process 905 of calculating an RTO correction value based on the RTT value corresponding to the CINR value. In the process 905, an RTT value corresponding to the CINR value acquired in the process 904 is obtained by referring to the information illustrated in FIG. 8, and the RTO correction value is calculated based on the obtained RTT value. In the process 905, a value for giving a margin to the time waiting for the receipt acknowledgement in reply to the transmitted packet may be added to the RTO correction value.

At the time when it is determined that the communication is in the “communication restart” state, the measurement of the CINR value is enable, but the measurement of the RTT value based on the packet in the TCP communication is unable because the communication has been in the “communication pause” state so far. Accordingly, in the process 905, the RTO correction value is calculated by indirectly obtaining the RTT value corresponding to the CINR value, which is measured when restarting the communication, based on the correlation between the RTT value and the CINR value both measured during the execution period of the TCP communication.

Thus, the process 905 enables the RTO correction value to be used, which is different from the RTO value used at the time when the communication has been brought into the “communication pause” state. Even when the radio-wave quality has changed during the “communication pause”, the communication is restarted using the RTO correction value adapted for the radio-wave quality after the change. For example, when the radio-wave quality has degraded during the “communication pause”, the RTO correction value, which is larger value than the RTO value used at the time when the communication was brought into the “communication pause” state, is set at the restart of the communication. Stated in another way, it is possible to avoid such an event that, after the restart of the communication, a timeout is generated because the RTO value is set to a smaller value than that corresponding to the actual radio-wave quality in spite of the communication device being able to receive the receipt conformation by waiting longer, and that the transmission rate is reduced, thus lowering the transfer rate. Hence the transfer rate is immediately set to a value adapted for the actual radio-wave quality.

The TCP processing portion 701 executes a process 906 of starting up a retransmission timer based on the RTO correction value. In the process 906, a time corresponding to the RTO correction value calculated in the process 905 is set in the retransmission timer, and the retransmission timer is started up.

The transmitting and receiving portion 706 executes a process 907 of transmitting a packet. With the process 907, a packet is transmitted in response to the data transmission request from the application portion 700.

Also when it is determined in the process 908 that the communication is in the “ordinary communication” state, the transmitting and receiving portion 706 executes a process 909 of transmitting a packet. With the process 909, a packet is transmitted in response to the data transmission request from the application portion 700.

The RTT measurement portion 705 executes a process 910 of measuring the RTT value. In the process 910, the RTT value is measured in accordance with the receipt acknowledgement that is transmitted by a communication device on the receiving side in reply to the packet transmitted in the process 909. More specifically, a time lapsed from the time of the transmission of the packet in the process 909 to the time of reception of the receipt acknowledgement is measured and set as the RTT value.

The radio-wave quality measurement portion 708 executes a process 911 of measuring the CINR value. In the process 911, as described above in connection with the process 904, the CINR value is measured based on the electric power of a radio signal communicated by the radio layers 14 and 24 to maintain the radio communication between the mobile communication terminal 10 and the base station 20.

The storage portion 707 executes a process 912 of storing the CINR value and the RTT value in corresponding relation. In the process 912, the RTT value measured in the process 910 and the CINR value measured in the process 911 are stored in the storage portion 707 in corresponding relation.

In EXAMPLE 1, as described above, the RTO correction value is calculated by indirectly obtaining the RTT value, which corresponds to the CINR value measured when restarting the communication, based on the correlation between the RTT value and the CINR value both measured during the execution period of the TCP communication. In accordance with the RTO correction value thus obtained, the retransmission determination time adapted for the radio-wave quality, which has changed during the “communication pause”, is set after the restart of the communication. As a result, the transfer rate is quickly converged to a proper rate, and the communication efficiency is increased.

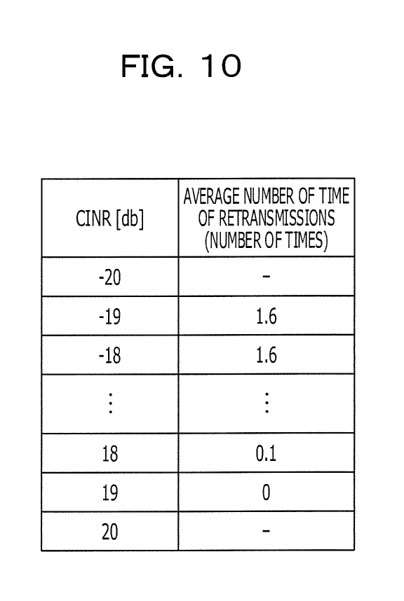

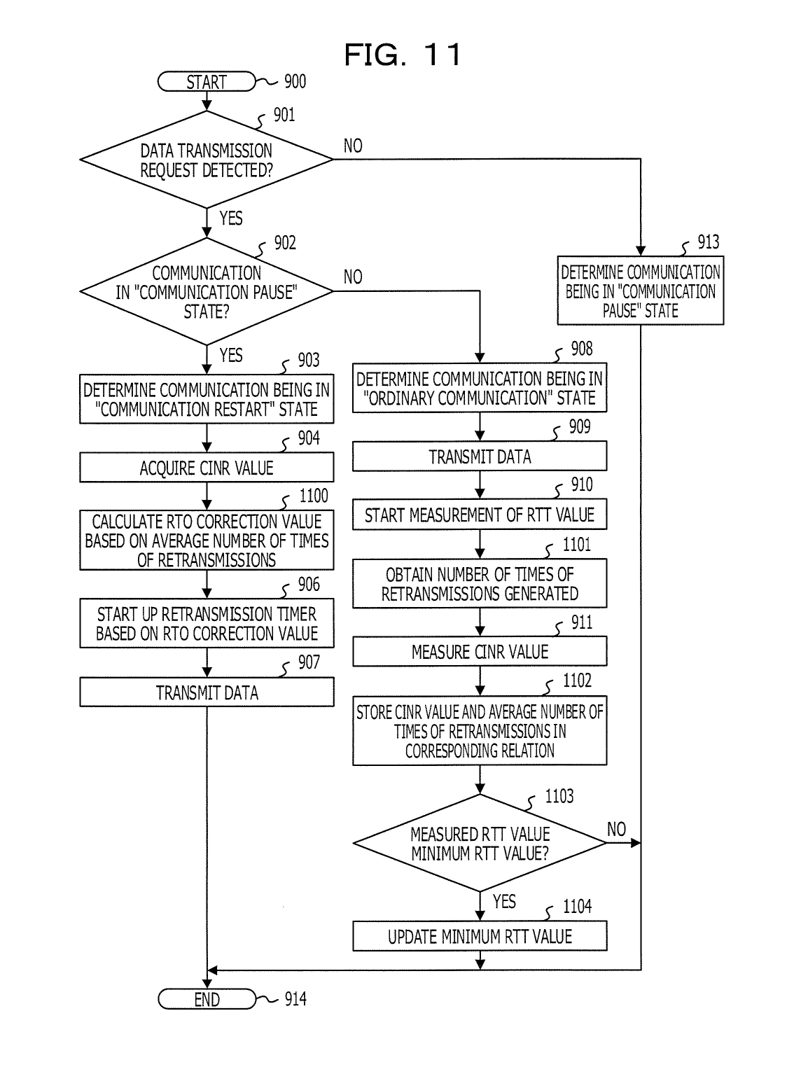

EXAMPLE 2 will be described below with reference to FIGS. 10 and 11. EXAMPLE 2 represents an embodiment in which, to increase the communication efficiency after the restart of the TCP communication, the retransmission determination time adapted for a change in the radio-wave quality is set by indirectly obtaining the RTT value corresponding to a retransmission processing time in a radio layer, which is estimated from the CINR value measured when restarting the communication, based on the correlation between the CINR value and the average number of times of retransmissions in the radio layer, both having being measured during the execution period of the TCP communication.

FIG. 10 illustrates an example of information used in processes executed in EXAMPLE 2. The information illustrated in FIG. 10 is information representing correspondence between the CINR value, which is one example of information related to the radio-wave quality of signals transmitted and received between the respective radio layers 14 and 24 in the mobile communication terminal 10 and the base station 20, and the average number of times of retransmissions in the radio layer 14. That information is stored in the memory 3 illustrated in FIG. 6, that is, the storage portion 707 in FIG. 7.

The storage portion 707 stores information representing, in corresponding relation, the average number of times of retransmissions in the radio layer 14, which has been measured by the retransmission control portion 715, and the CINR value, which has been measured by the radio-wave quality measurement portion 708, after the start of the data communication by the application portion 700. That information is illustrated in FIG. 10. The stored information indicates, for example, such correspondence that when the CINR value is “−18” [db], the average number of times of retransmissions is “1.6” [number of times]. When the average number of times of retransmissions corresponding to the measured CINR value is already stored, a weighted average value of the average number of times of retransmissions corresponding to the measured CINR value and the already-stored the average number of times of retransmissions may be used. Alternatively, the average number of times of retransmissions corresponding to the measured CINR value may be used as it is.

The storage portion 707 further stores a time taken for one retransmission process in the radio layer 14, that is, a unit time taken for the retransmission process. The unit time may be measured or calculated through numerical computation in advance. More specifically, the information stored in the storage portion 707 is not limited to the correspondence between the CINR value and the average number of times of retransmissions, and may be information representing correspondence between an average retransmission processing time, which is resulted from multiplying the average number of times of retransmissions by the unit time taken for the retransmission process, and the CINR value.

The storage portion 707 still further stores minimum one of the RTT values that have been measured by the RTT measurement portion 705 after the start of the data communication by the application portion 700.

FIG. 11 illustrates an example of processes executed in EXAMPLE 2. It is to be noted that, in the description of FIG. 11, the same process as that illustrated in FIG. 9 is denoted by the same reference symbol and duplicate description is omitted.

Subsequent to the process 904, the RTO correction portion 704 executes a process 1100 of calculating the RTO correction value based on the average number of times of retransmissions. In the process 1100, the average number of times of retransmissions corresponding to the CINR value, which has been acquired in the process 904, is obtained by referring to the information illustrated in FIG. 10. The average retransmission time corresponding to the CINR value is then calculated by multiplying the obtained average number of times of retransmissions by the unit time taken for the retransmission process, the unit time being stored in the storage portion 707. The RTO correction value is further calculated by adding minimum one of the RTT values, stored in the storage unit 707, to the calculated average retransmission time. In the process 1100, a value for giving a margin to the time waiting for the receipt acknowledgement in reply to the transmitted packet may be added to the RTO correction value. After the end of the process 1100, the control flow shifts to the process 906.

At the time when it is determined that the communication is in the “communication restart” state, the measurement of the CINR value is enable, but the measurement of the RTT value based on the packet in the TCP communication is unable because the communication has been in the “communication pause” state so far. Accordingly, in the process 1100, the RTO correction value is calculated by indirectly obtaining the RTT value corresponding to the retransmission processing time in the radio layer 14, which is estimated from the CINR value measured when restarting the communication, based on the correlation between the CINR value and the average number of times of retransmissions in the radio layer 14, both measured during the execution period of the TCP communication.

Thus, the process 1100 enables the RTO correction value to be used, which is different from the RTO value used at the time when the communication has been brought into the “communication pause” state. Even when the radio-wave quality has changed during the “communication pause”, the communication is restarted using the RTO correction value adapted for the average number of times of retransmissions corresponding to the radio-wave quality at the restart of the communication.

Subsequent to the process 910, the retransmission control portion 715 executes a process 1101 of obtaining the number of times of retransmissions generated. In the process 1101, the number of times of retransmissions generated in the radio layer 14 is measured.

The storage portion 707 executes a process 1102 of storing the CINR value and the number of times of retransmissions in corresponding relation. In the process 1102, the average number of times of retransmissions, which is obtained based on the number of times of retransmissions obtained in the process 1101, and the CINR value measured in the process 911 are stored in the storage portion 707 in corresponding relation.

The RTT measurement portion 705 executes a process 1103 of determining whether the measured RTT value is smaller than the minimum one of the RTT values. In the process 1103, the RTT value measured in the process 910 is compared with the minimum one of the RTT values stored in the storage portion 707. If the measured RTT value is smaller than the minimum one of the RTT values, the control flow shifts to a process 1104, and if the measured RTT value is not smaller than the minimum one of the RTT values, it shifts to the process 914.

The RTT measurement portion 705 executes the process 1104 of updating the minimum RTT value. In the process 1104, the RTT value measured in the process 910 is stored as the minimum RTT value in the storage portion 707. After the end of the process 1104, the control flow shifts to the process 914.

In EXAMPLE 2, as described above, the RTO correction value is calculated by indirectly obtaining the RTT value corresponding to the retransmission processing time, which is estimated from the CINR value measured when restarting the communication, based on the correlation between the CINR value and the average number of times of retransmissions in the radio layer 14, both measured during the execution period of the TCP communication. In accordance with the RTO correction value thus obtained, the retransmission determination time adapted for the radio-wave quality, which has changed during the “communication pause”, is set after the restart of the communication. As a result, the transfer rate is quickly converged to a proper rate, and the communication efficiency is increased.

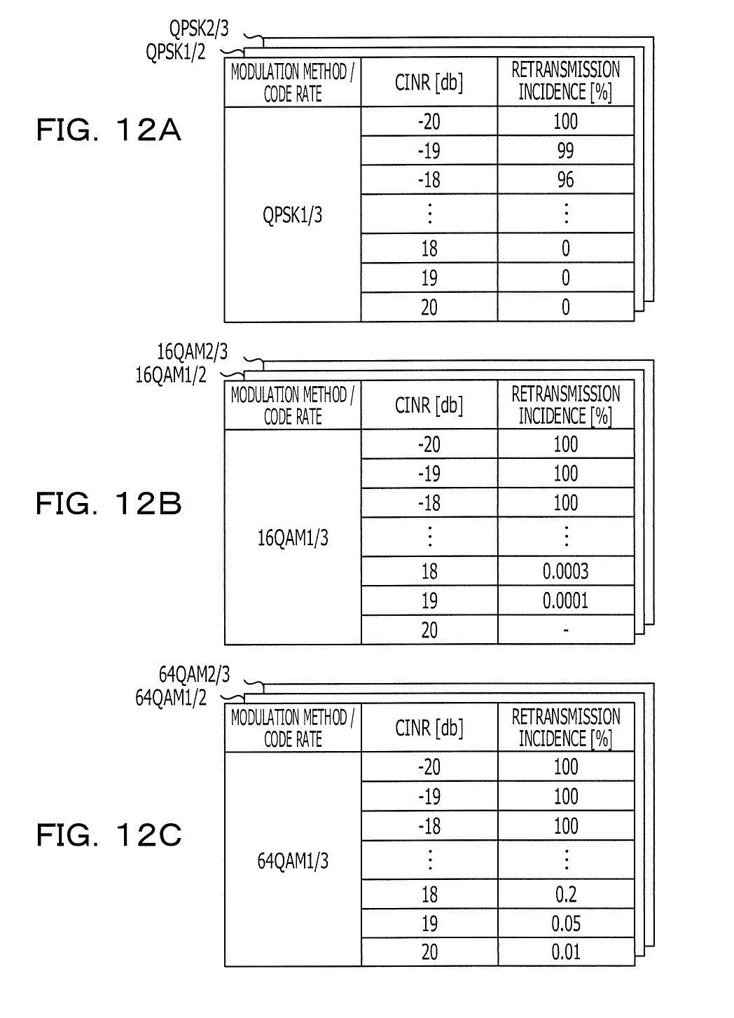

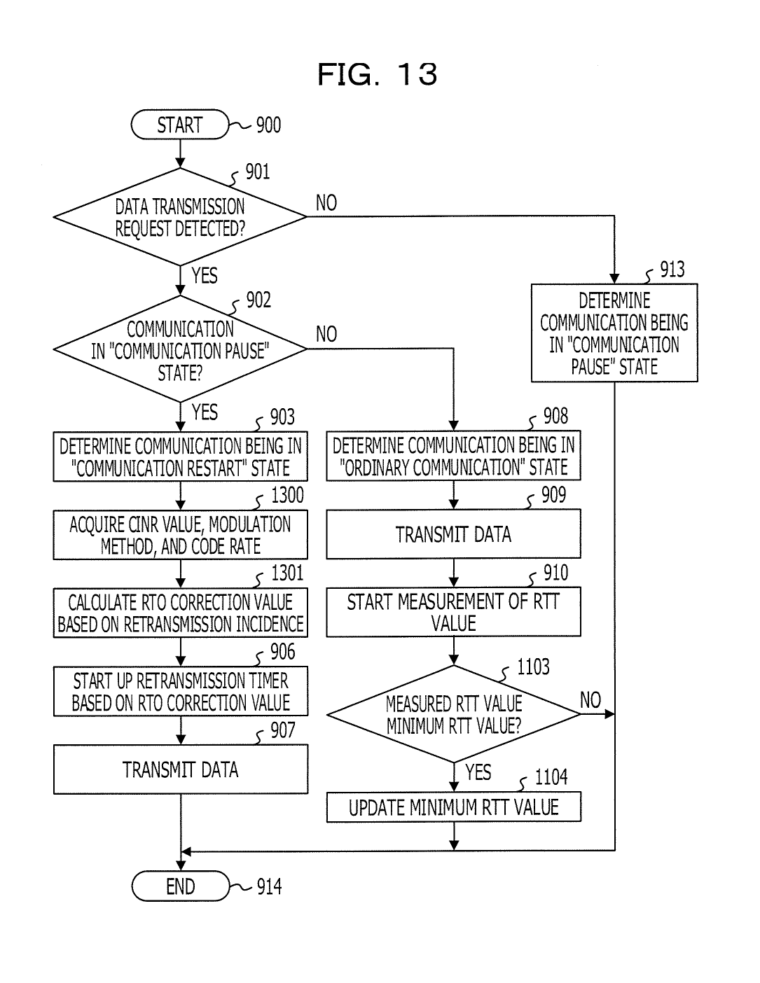

EXAMPLE 3 will be described below with reference to FIGS. 12 and 13. EXAMPLE 3 represents an embodiment in which, to increase the communication efficiency after the restart of the TCP communication, the retransmission determination time adapted for a change in the radio-wave quality is set by indirectly obtaining the RTT value corresponding to a retransmission processing time in a radio layer, which is estimated from a modulation method and a code rate each employed when restarting the communication, based on the modulation method and the code rate of signals transmitted from and received by the radio layer.

FIG. 12 illustrates an example of information used in processes executed in EXAMPLE 3. The information illustrated in FIG. 12 is information representing correspondence between the CINR value, which is one example of information related to the radio-wave quality of signals transmitted and received between the respective radio layers 14 and 24 in the mobile communication terminal 10 and the base station 20 and which is given when the modulation method and the code rate are specified, and a retransmission incidence in the radio layer 14. That information is stored in the memory 3 illustrated in FIG. 6, that is, the storage portion 707 in FIG. 7. FIG. 12A represents the case where the modulation method is quadrature phase shift keying (QPSK), FIG. 12B represents the case where the modulation method is 16 quadrature amplitude modulation (16QAM), and FIG. 12C represents the case where the modulation method is 64 quadrature amplitude modulation (64QAM).

As illustrated in FIG. 12A, the storage portion 707 stores, for each code rate, the correspondence between the CINR value and the retransmission incidence when the modulation method is the QPSK. FIG. 12A illustrates an example in which the storage portion 707 stores the correspondences when the code rate is “⅓”, “½”, and “⅔”. In one example of the correspondences, when the modulation method is the QPSK and the code rate is “⅓”, the retransmission incidence is “96” [%] in the case of the CINR value being “−18” [db]. The retransmission incidence may be measured or calculated through numerical computation in advance.

As illustrated in FIG. 12B, the storage portion 707 stores, for each code rate, the correspondence between the CINR value and the retransmission incidence when the modulation method is the 16QAM. FIG. 12B illustrates an example in which the storage portion 707 stores the correspondences when the code rate is “⅓”, “½”, and “⅔”. In one example of the correspondences, when the modulation method is the 16QAM and the code rate is “⅓”, the retransmission incidence is “100” [%] in the case of the CINR value being “−18” [db]. The retransmission incidence may be measured or calculated through numerical computation in advance.

As illustrated in FIG. 12C, the storage portion 707 stores, for each code rate, the correspondence between the CINR value and the retransmission incidence when the modulation method is the 64QAM. FIG. 12C illustrates an example in which the storage portion 707 stores the correspondences when the code rate is “⅓”, “½”, and “⅔”. In one example of the correspondences, when the modulation method is the 64QAM and the code rate is “⅓”, the retransmission incidence is “100” [%] in the case of the CINR value being “−18” [db]. The retransmission incidence may be measured or calculated through numerical computation in advance.

The storage portion 707 further stores a time taken for one retransmission process in the radio layer 14, that is, a unit time taken for the retransmission process. The unit time may be measured or calculated through numerical computation in advance. More specifically, the information stored in the storage portion 707 is not limited to the correspondence between the CINR value and the retransmission incidence, and may be information representing correspondence between an average retransmission processing time, which is resulted from multiplying the retransmission incidence by the unit time taken for the retransmission process, and the CINR value.

The storage portion 707 still further stores minimum one of the RTT values that have been measured by the RTT measurement portion 705 after the start of the data communication by the application portion 700.

FIG. 13 illustrates an example of processes executed in EXAMPLE 3. It is to be noted that, in the description of FIG. 13, the same process as that illustrated in FIGS. 9 and 11 is denoted by the same reference symbol and duplicate description is omitted.

Subsequent to the process 903, the lower-layer information acquisition portion 703 executes a process 1300 of acquiring the CINR value, the modulation method, and the code rate. In the process 1300, the CINR value representing the radio-wave quality measured by the radio-wave quality measurement portion 708 is acquired by the lower-layer information acquisition portion 703. Furthermore, the lower-layer information acquisition portion 703 acquires the modulation method and the code rate, which are employed at that time, from the modulation/demodulation and coding/decoding processing portion 716. The CINR value acquired in the process 1300 is the CINR value, which is calculated based on the electric power of radio communication transmitted and received by the radio layers 14 and 24 to maintain the radio communication between the mobile communication terminal 10 and the base station 20, like the CINR value acquired in the above-described process 904.

The RTO correction portion 704 executes a process 1301 of calculating the RTO correction value based on the retransmission incidence. In the process 1301, the information illustrated in one of FIGS. 12A, 12B and 12C is referred based on the modulation method and the code rate, which have been acquired in the process 1300. The retransmission incidence corresponding to the CINR value acquired in the process 1300 is obtained from the referred information. The average retransmission processing time corresponding to the CINR value is then calculated by multiplying the obtained retransmission incidence by the unit time taken for the retransmission process, the unit time being stored in the storage portion 707. The RTO correction value is calculated by adding the minimum RTT value, which is stored in the storage portion 707, to the average retransmission processing time. In the process 1301, a value for giving a margin to the time waiting for the receipt acknowledgement in reply to the transmitted packet may be added to the RTO correction value. After the end of the process 1301, the control flow shifts to the process 906.

At the time when it is determined that the communication is in the “communication restart” state, the measurement of the CINR value is enable, but the measurement of the RTT value based on the packet in the TCP communication is unable because the communication has been in the “communication pause” state so far. Accordingly, in the process 1301, the RTO correction value is calculated by indirectly obtaining the RTT value corresponding to the CINR value, which is measured when restarting the communication, based on the correlation between the retransmission incidence in the radio layer 14 and the CINR value.

Thus, the process 1301 enables the RTO correction value to be used, which is different from the RTO value used at the time when the communication has been brought into the “communication pause” state. Even when the radio-wave quality has changed during the “communication pause”, the communication is restarted using the RTO correction value adapted for the retransmission incidence corresponding to the radio-wave quality at the restart of the communication.

In EXAMPLE 3, as described above, the RTO correction value is calculated by indirectly obtaining the RTT value corresponding to the retransmission processing time in the radio layer 14, which is estimated from the modulation method and the code rate employed when restarting the communication, based on the correlation between the CINR value and the retransmission incidence in the radio layer 14 when the modulation method and the code rate of signals transmitted from and received by the radio layer 14 are specified. In accordance with the RTO correction value thus obtained, the retransmission determination time adapted for the radio-wave quality, which has changed during the “communication pause”, is set after the restart of the communication. As a result, the transfer rate is quickly converged to a proper rate, and the communication efficiency is increased.

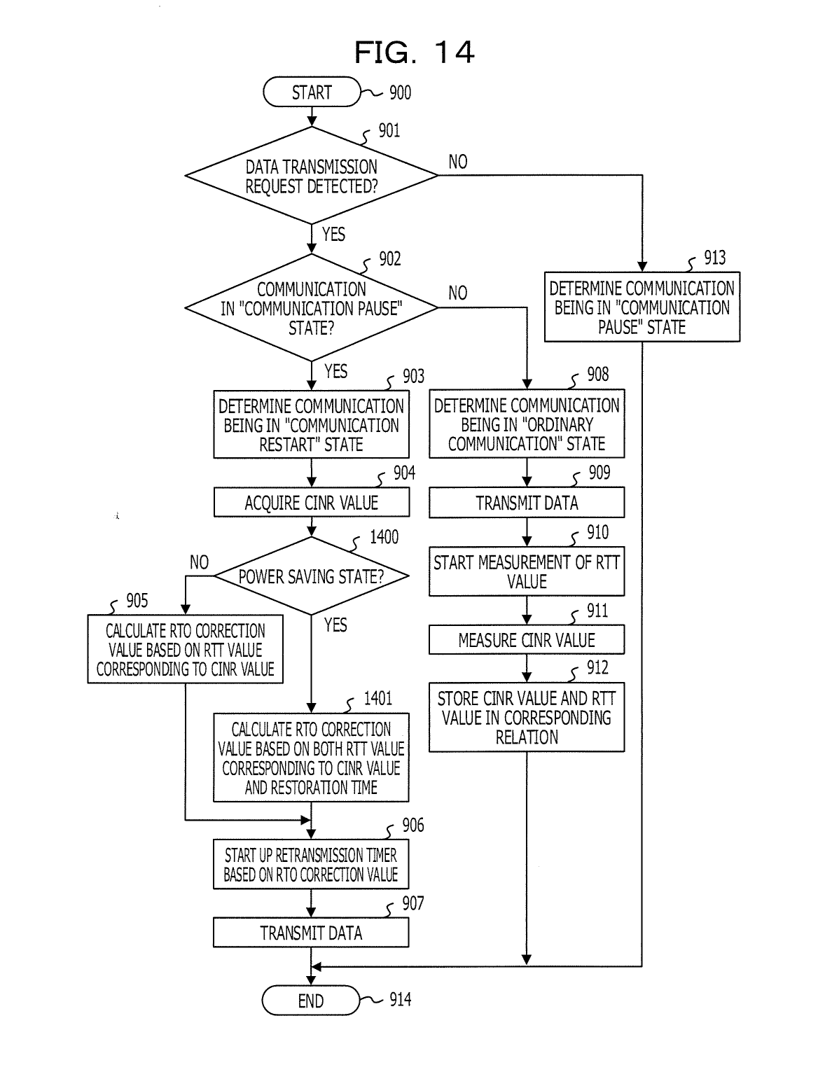

FIG. 14 illustrates an example of processes executed in EXAMPLE 4. In EXAMPLE 4, to increase the communication efficiency after the restart of the TCP communication, when a communication device and a radio layer of a communication device are in a power saving state, the RTO correction value is calculated not only by employing the RTT value corresponding to the CINR value as in EXAMPLE 1, but also considering a restoration time taken for a restoration process from the power saving state.

The term “power saving state” implies an operating state where power consumption is reduced by pausing operations of part of communication circuits and all or part of circuits for realizing the radio layer, and by limiting supply of electric power to those circuits. The term “the restoration time” implies a time taken to restore the circuits from the power saving state to an operating state capable of restarting the communication. The restoration time is previously measured or calculated through numerical computation, and a typical certain value of the restoration time is stored in the storage portion 707. It is to be noted that, in the description of FIG. 14, the same process as that illustrated in FIG. 9 is denoted by the same reference symbol and duplicate description is omitted.

Subsequent to the process 904, the power-saving state determination portion 713 executes a process 1400 of determining whether the relevant circuits are in the power saving state. In the process 1400, whether the relevant circuits are in the power saving state is determined by the power-saving state determination portion 713 detecting that a value of currents flowing through the part of communication circuits and all or the part of circuits for realizing the radio layer is smaller than a certain value. If the relevant circuits are not in the power saving state, the control flow shifts to the process 905, and if the relevant circuits are in the power saving state, the control flow shifts to a process 1401.

The RTO correction portion 704 executes the process 1401 of calculating the RTO correction value based on the RTT value corresponding to both the CINR value and the restoration time. In the process 1401, the RTT value corresponding to the CINR value, which has been acquired in the process 904, is obtained by referring to the information illustrated in FIG. 8. Furthermore, the restoration time taken for the restoration from the power saving state is obtained from the storage portion 707. The RTO correction value is then calculated by adding the RTT value and the restoration time, obtained as described above, to each other. In the process 1401, a value for giving a margin to the time waiting for the receipt acknowledgement in reply to the transmitted packet may be added to the RTO correction value.

At the time when it is determined that the communication is in the “communication restart” state, the measurement of the CINR value is enable, but the measurement of the RTT value based on the packet in the TCP communication is unable because the communication has been in the “communication pause” state so far. Accordingly, in the process 1401, the RTO correction value is calculated by indirectly obtaining the RTT value corresponding to the CINR value, which is measured when restarting the communication, based on the correlation between the RTT value and the CINR value both measured during the execution period of the TCP communication, and further by considering the restoration time taken for the restoration from the power saving state.

Thus, the process 1401 enables the RTO correction value to be used, which is different from the RTO value used at the time when the communication has been brought into the “communication pause” state. Even when the radio-wave quality has changed during the “communication pause”, the communication is restarted using the RTO correction value, which is calculated by additionally taking into consideration the restoration time from the power saving state to be adapted for the radio-wave quality at the restart of the communication.

In EXAMPLE 4, as described above, the RTO correction value is calculated by indirectly obtaining the RTT value corresponding to the CINR value, which is measured when restarting the communication, based on the correlation between the RTT value and the CINR value both measured during the execution period of the TCP communication. Moreover, when the communication device and the radio layer are in the power saving state before the restart of the communication, the RTO correction value is set to a more appropriate value by adding, to the above-mentioned RTO correction value, the time taken for restoring from the power saving state and restarting the communication. In accordance with the RTO correction value thus obtained, the retransmission determination time adapted for both the radio-wave quality and the operating state, which have changed during the “communication pause”, is set after the restart of the communication. As a result, the transfer rate is quickly converged to a proper rate, and the communication efficiency is increased.

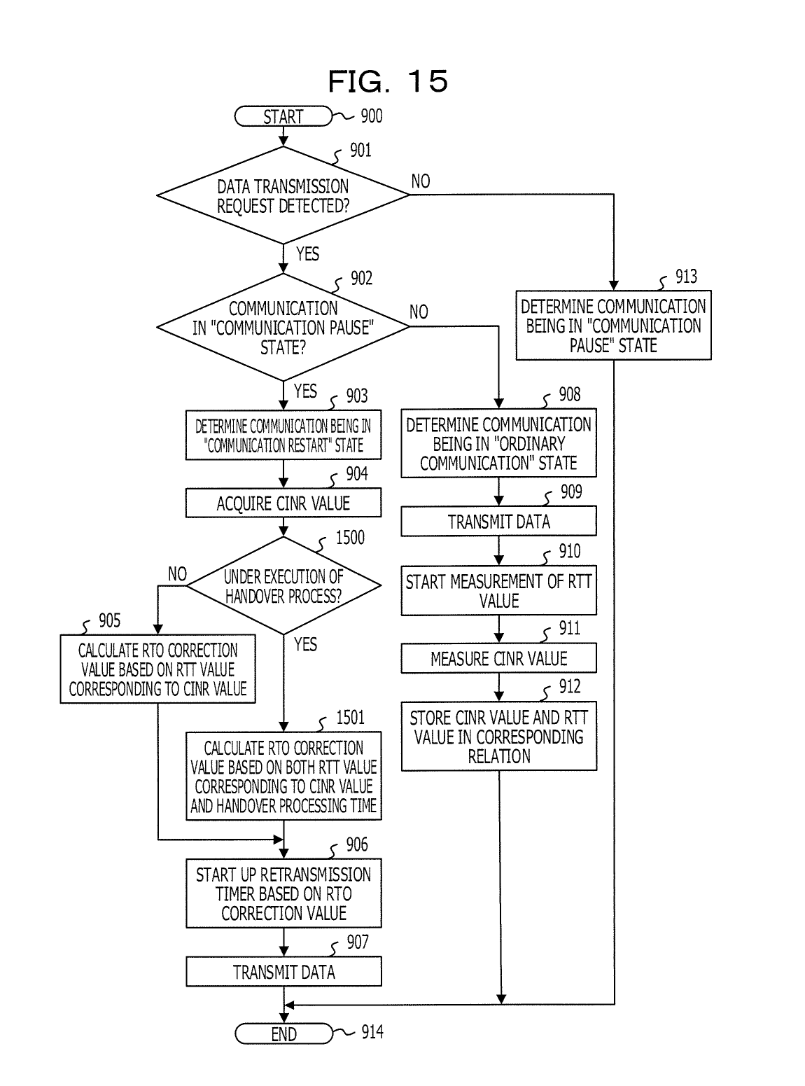

FIG. 15 illustrates an example of processes executed in EXAMPLE 5. In EXAMPLE 5, to increase the communication efficiency after the restart of the TCP communication, when a radio layer is under execution of the handover process, the RTO correction value is calculated not only by employing the RTT value corresponding to the CINR value as in EXAMPLE 1, but also by considering a processing time taken for the handover process. The processing time taken for the handover process is a processing time taken for the mobile communication terminal 10 to change the base station 20 with which the radio communication is performed. The handover processing time is previously measured or calculated through numerical computation, and a typical certain value of the processing time is stored as information in the storage portion 707. It is to be noted that, in the description of FIG. 15, the same process as that illustrated in FIG. 9 is denoted by the same reference symbol and duplicate description is omitted.

Subsequent to the process 904, the handover execution determination portion 711 executes a process 1500 of determining whether the handover process is under execution. The process 1500 is executed, for example, by the handover execution determination portion 711 monitoring the state of the handover processing portion 710 that executes the handover process. If it is determined that the handover process is not under execution, the control flow shifts to the process 905, and if it is determined that the handover process is under execution, the control flow shifts to a process 1501.

The RTO correction portion 704 executes the process 1501 of calculating the RTO correction value based on both the RTT value corresponding to the CINR value and the handover processing time. In the process 1501, the RTT value corresponding to the CINR value, which has been acquired in the process 904, is obtained by referring to the information illustrated in FIG. 8. Furthermore, the handover processing time is obtained from the storage portion 707. The RTO correction value is then calculated by adding the RTT value and the handover processing time, obtained as described above, to each other. In the process 1501, a value for giving a margin to the time waiting for the receipt acknowledgement in reply to the transmitted packet may be added to the RTO correction value.

At the time when it is determined that the communication is in the “communication restart” state, the measurement of the CINR value is enable, but the measurement of the RTT value based on the packet in the TCP communication is unable because the communication has been in the “communication pause” state so far. Accordingly, in the process 1501, the RTO correction value is calculated by indirectly obtaining the RTT value corresponding to the CINR value, which is measured when restarting the communication, based on the correlation between the RTT value and the CINR value both measured during the execution period of the TCP communication, and further by considering the processing time taken for the handover process.

Thus, the process 1501 enables the RTO correction value to be used, which is different from the RTO value used at the time when the communication has been brought into the “communication pause” state. Even when the radio-wave quality has changed during the “communication pause”, the communication is restarted using the RTO correction value, which is calculated by additionally taking into consideration the processing time taken for the handover process to be adapted for the radio-wave quality at the restart of the communication.

In EXAMPLE 5, as described above, the RTO correction value is calculated by indirectly obtaining the RTT value corresponding to the CINR value, which is measured when restarting the communication, based on the correlation between the RTT value and the CINR value both measured during the execution period of the TCP communication. Moreover, when the handover process is under execution before the restart of the communication, the RTO correction value is set to a more appropriate value by adding, to the above-mentioned RTO correction value, the processing time taken for the handover process. In accordance with the RTO correction value thus obtained, the retransmission determination time adapted for both the radio-wave quality and the operating state, which have changed during the “communication pause”, is set after the restart of the communication. As a result, the transfer rate is quickly converged to a proper rate, and the communication efficiency is increased.

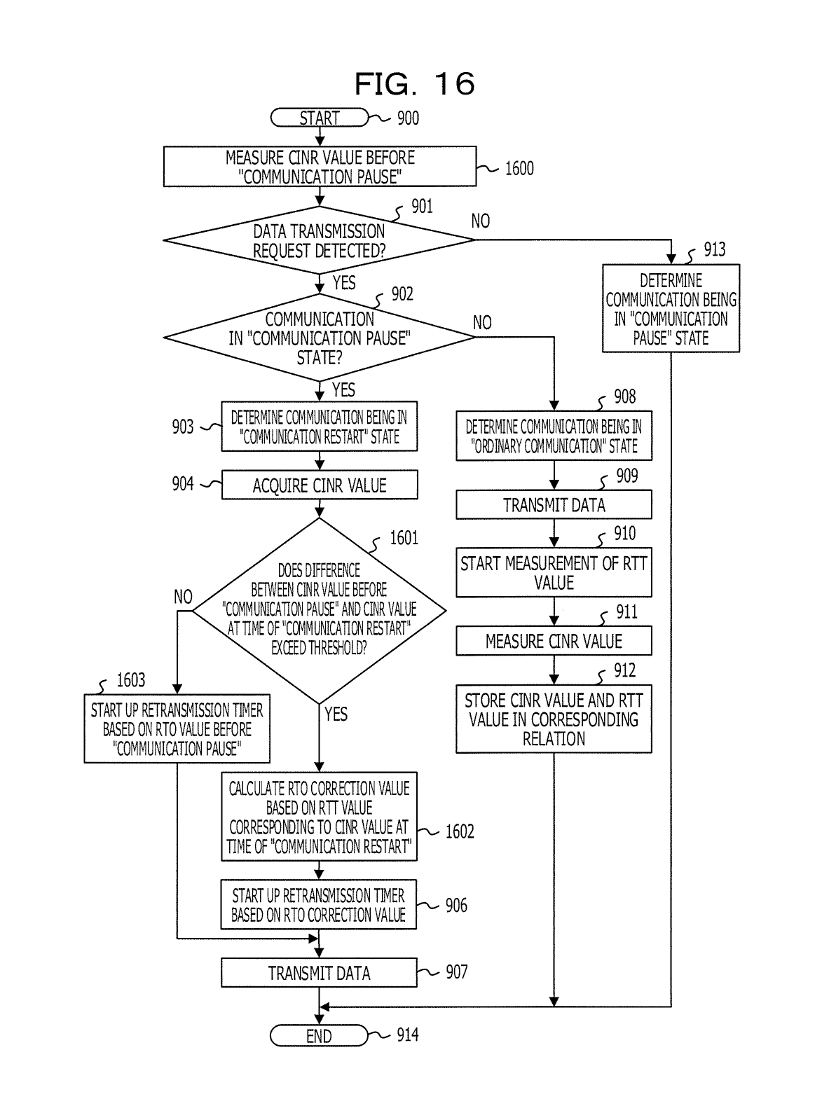

FIG. 16 illustrates an example of processes executed in EXAMPLE 6. In EXAMPLE 6, the RTO correction value is calculated if the CINR value measured when restarting the TCP communication is reduced in excess of a certain extent from the CINR value at the time when the TCP communication has been paused, thus taking balance between an improvement of the communication efficiency after the restart of the TCP communication and a reduction of the processing load imposed on calculation of the RTO correction value. It is to be noted that, in the description of FIG. 16, the same process as that illustrated in FIG. 9 is denoted by the same reference symbol and duplicate description is omitted.

The radio-wave quality measurement portion 708 executes a process 1600 of measuring the CINR value before the “communication pause”. In the process 1600, for example, when the communication restart detection portion 702 determines the “communication pause” upon not detecting the data transmission request from the application portion 700 and notifies the “communication pause” to the radio-wave propagation environment determination portion 709, the CINR value at that time is measured by the radio-wave quality measurement portion 708 and is stored in the storage portion 707. After the end of the process 1600, the control flow shifts to the process 901.

Subsequent to the process 904, the RTO correction portion 704 executes a process 1601 of determining whether the difference between the CINR value at the time of the “communication pause” and the CINR value at the time of the “communication restart” exceeds a threshold. In the process 1601, the difference between the CINR value at the time of the “communication pause”, which is measured in the process 1600, and the CINR value at the time of the “communication restart”, which is acquired in the process 904, is calculated, and whether the calculated difference exceeds a threshold is determined. If it is determined that the calculated difference exceeds the threshold, this is regarded as indicating that the radio-wave quality has degraded in excess of a certain extent, and the control flow shifts to a process 1602. If it is determined that the calculated difference does not exceed the threshold, the control flow shifts to a process 1603.

The RTO correction portion 704 executes the process 1602 of calculating the RTO correction value based on the RTT value corresponding to the CINR value at the time of the “communication restart”. In the process 1602, upon judgment that the radio-wave quality has degraded in excess of a certain extent during the “communication pause”, the RTT value corresponding to the CINR value, which is acquired at the time of the “communication restart”, instead of the CINR value at the time of the “communication pause” is obtained based on the information illustrated in FIG. 8. The RTO correction value is then calculated based on the obtained RTT value. After the end of the process 1602, the control flow shifts to the process 906.

Thus, the process 1602 enables the RTO correction value to be used, which is different from the RTO value used at the time when the communication has been brought into the “communication pause” state. As a result, the communication is restarted using the RTO correction value adapted for the radio radio-wave quality that has degraded during the “communication pause”.

The TCP processing portion 701 executes the process 1603 of starting up the retransmission timer based on the RTO value before the “communication pause”. In the process 1603, the retransmission timer is started up by setting, in the retransmission timer, a time based on the RTO value having been calculated before the “communication pause”, while the process of calculating the RTO correction value is omitted upon the judgment that the radio-wave quality has not degraded in excess of a certain extent during the “communication pause”. In other words, when the radio-wave quality has not degraded during the “communication pause”, the processing load imposed when restarting the communication is reduced. After the end of the process 1603, the control flow shifts to the process 907.

In EXAMPLE 6, as described above, the balance between the improvement of the communication efficiency after the restart of the TCP communication and the reduction of the processing load imposed on the calculation of the RTO correction value is taken depending on a change in the radio-wave quality during the pause period of the TCP communication.

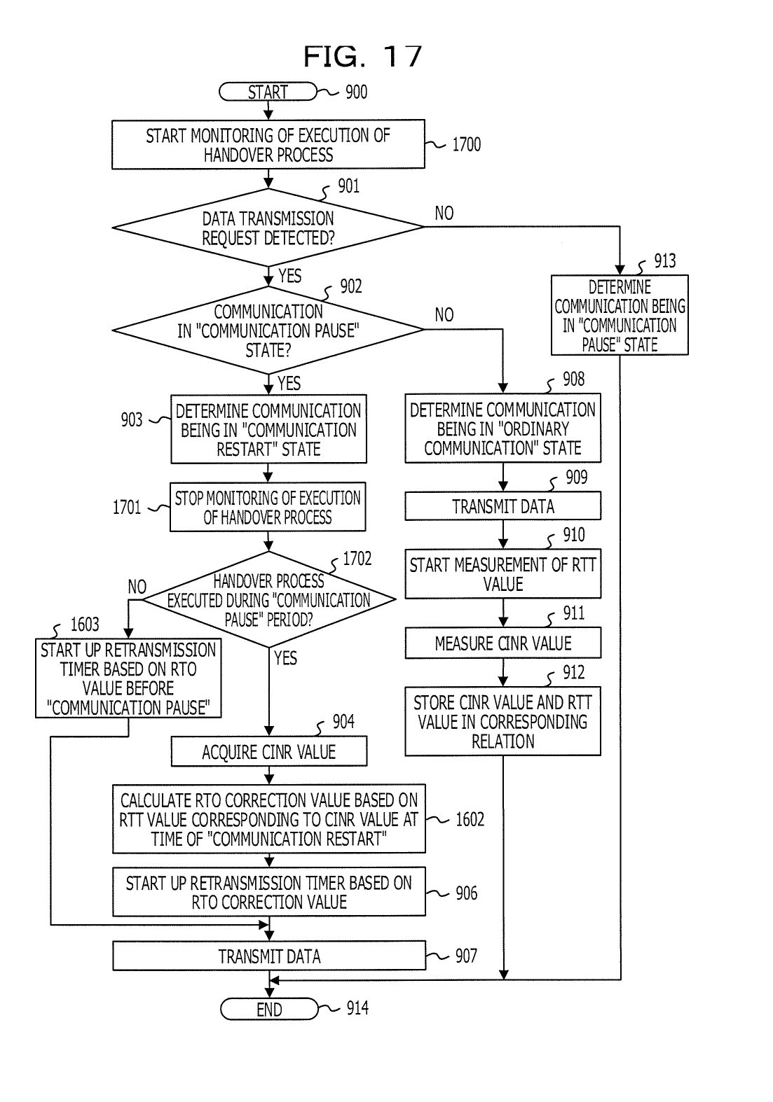

FIG. 17 illustrates an example of processes executed in EXAMPLE 7. There is a high possibility of a change in the radio-wave quality if the handover process has been executed during the pause period of the TCP communication. In EXAMPLE 7, therefore, the RTO correction value is calculated in the above-mentioned case to take balance between an improvement of the communication efficiency after the restart of the TCP communication and a reduction of the processing load imposed on calculation of the RTO correction value. It is to be noted that, in the description of FIG. 17, the same process as that illustrated in FIGS. 9 and 16 is denoted by the same reference symbol and duplicate description is omitted.

The handover execution determination portion 711 executes a process 1700 of starting to monitor the execution of the handover process. In the process 1700, for example, when the communication restart detection portion 702 determines the “communication pause” upon not detecting the data transmission request from the application portion 700 and notifies the “communication pause” to the handover execution determination portion 711, the handover execution determination portion 711 starts monitoring of the handover processing portion 710. After the end of the process 1700, the control flow shifts to the process 901.

Subsequent to the process 903, if it is determined that the communication is in the “communication restart” state, the handover execution determination portion 711 executes a process 1701 of stopping the monitoring of the execution of the handover process.

The handover execution determination portion 711 executes a process 1702 of determining whether the handover process has been executed during the “communication pause”. In the process 1702, for example, if the monitoring in the process 1700 detects that the handover process has been executed during the “communication pause”, this is regarded as indicating that the handover has been made, and the control flow shifts to the process 904. On the other hand, if the handover process has not been executed, the control flow shifts to the process 1603.

In EXAMPLE 7, as described above, considering that a possibility of a change in the radio-wave quality is high if the handover process has been executed during the pause period of the TCP communication, the RTO correction value is calculated in such a case, thus taking the balance between the improvement of the communication efficiency after the restart of the TCP communication and the reduction of the processing load imposed on the calculation of the RTO correction value.

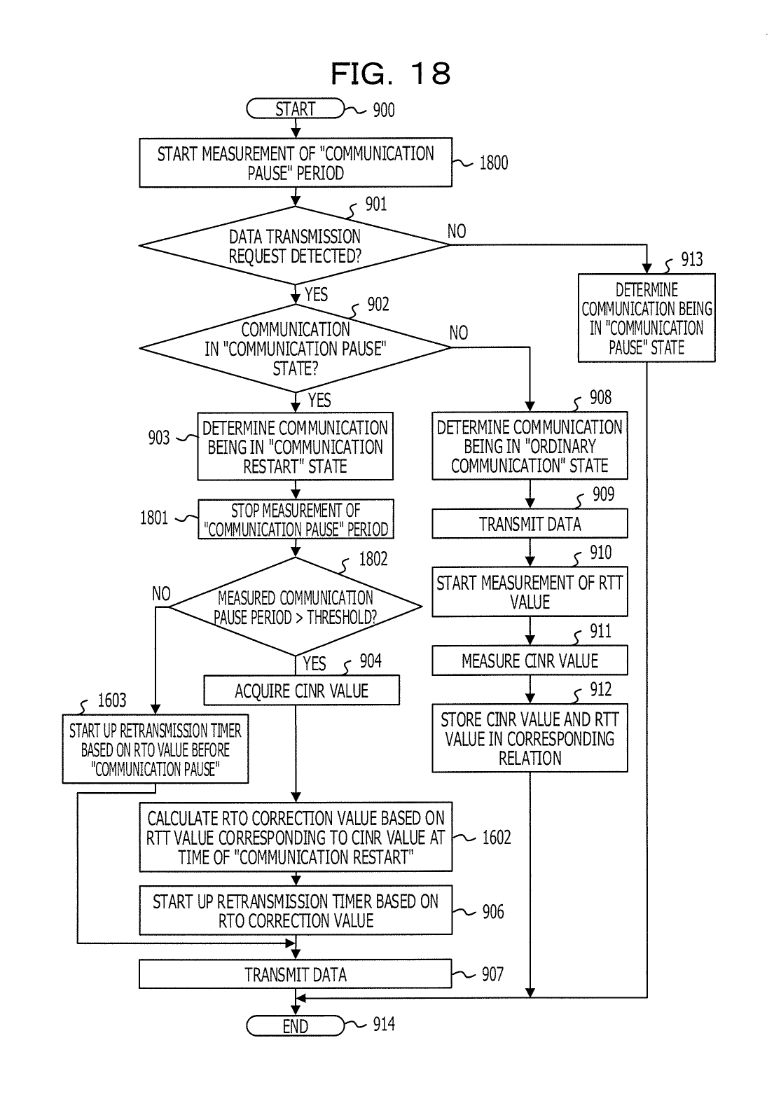

FIG. 18 illustrates an example of processes executed in EXAMPLE 8. If the pause period of the TCP communication exceeds a certain period, there is a high possibility that the radio-wave quality has changed during the pause period. In EXAMPLE 8, therefore, the RTO correction value is calculated in the above-mentioned case to take balance between an improvement of the communication efficiency after the restart of the TCP communication and a reduction of the processing load imposed on calculation of the RTO correction value. It is to be noted that, in the description of FIG. 18, the same process as that illustrated in FIGS. 9 and 16 is denoted by the same reference symbol and duplicate description is omitted.

The communication pause period determination portion 714 executes a process 1800 of starting the measurement of a communication pause period. In the process 1800, for example, when the communication restart detection portion 702 determines the “communication pause” upon not detecting the data transmission request from the application portion 700 and notifies the “communication pause” to the communication pause period determination portion 714, the communication pause period determination portion 714 starts the measurement of the communication pause period. After the end of the process 1800, the control flow shifts to the process 901.

Subsequent to the process 903, if it is determined that the communication is in the “communication restart” state, the communication pause period determination portion 714 executes a process 1801 of stopping the measurement of the communication pause period.

The communication pause period determination portion 714 executes a process 1802 of determining whether the communication pause period exceeds a threshold. In the process 1802, for example, if the measured communication pause period exceeds the threshold, the control flow shifts to the process 904 to calculate the RTO correction value because the possibility that the radio-wave quality has changed during the communication pause period is high. If it is determined that the communication pause period does not exceed the threshold, the control flow shifts to the process 1603.

In EXAMPLE 8, as described above, considering that if the pause period of the TCP communication exceeds a certain period, there is a high possibility that the radio-wave quality has changed during the pause period, the RTO correction value is calculated in such a case, thus taking the balance between the improvement of the communication efficiency after the restart of the TCP communication and the reduction of the processing load imposed on the calculation of the RTO correction value.

The determination conditions described above in EXAMPLES 4 to 8 may be applied to not only the case using the CINR value as in EXAMPLES 1 and 2, but also the case where the modulation method and the code rate are used to correct the RTT value as in EXAMPLE 3.

According to the embodiments described above, the retransmission determination time in the packet communication in accordance with the protocol in an upper-level communication layer is set by employing information representing the communication state of a lower-level communication layer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a memory; and
a processor coupled to the memory and configured to execute a process, the process including:
setting a retransmission determination time for a packet complying with a protocol of a first layer based on a communication state of a second layer that is lower than the first layer.

2. The communication device of claim 1,
wherein the process further includes:
setting the retransmission determination time by updating the retransmission determination time that was set in the first layer based on the communication state of second layer.

3. The communication device of claim 1,
wherein the packet complying with the protocol of the first layer is transmitted from the communication device to another communication device via a base station,
the communication state of the second layer includes a communication state of the second layer between the communication device and the base station, and
the retransmission determination time includes a time to determine whether the packet complying with the protocol of the first layer is to be retransmitted to the another communication device.

4. The communication device of claim 1,
wherein the second layer includes a radio layer.

5. The communication device of claim 1,
wherein the process further includes:
setting the retransmission determination time based on the communication state of second layer when a transmission of the packet complying with the protocol of the first layer is paused.

6. The communication device of claim 1,
wherein the communication state of second layer includes information obtained during a period in which a transmission of the packet complying with the protocol of the first layer is paused, and
wherein the process further includes:
setting the retransmission determination time based on the communication state of second layer when the packet communication is restarted.

7. The communication device of claim 1,
wherein the process further includes:
setting the retransmission determination time that set in the first layer in response to a receipt of an acknowledgement for the packet complying with the protocol of the first layer.

8. The communication device of claim 1,
wherein, depending on transmission of the packet complying with the protocol of the first layer, the communication state of second layer is correlated with the retransmission determination time that is set in response to a receipt of an acknowledgement.

9. The communication device of claim 1,
wherein the process further includes:
setting the retransmission determination time based on the communication state of the second layer when the communication device executes a handover process.

10. The communication device of claim 1,
wherein the process further includes:
setting the retransmission determination time based on the communication state of second layer when a pause period of transmission of the packet complying with the protocol of the first layer is longer than a threshold time.

11. The communication device of claim 1,
wherein the process further includes:
setting the retransmission determination time based on second-layer communication state when the communication device is in a power saving state.

12. The communication device of claim 1,
wherein the communication state of second layer includes information related to radio-wave quality of a signal in the second layer.

13. The communication device of claim 12,
wherein the process further includes:
setting the retransmission determination time based on the communication state of second layer when a difference between the radio-wave quality at time when packet transmission of the packet complying with the protocol of the first layer is paused and the radio-wave quality at time when the packet transmission is restarted is not less than a threshold

14. The communication device of claim 12,
wherein the information related to radio-wave quality includes one or more of power information, a modulation method, a code rate, or a number of times of retransmissions.

15. The communication device of claim 1,
wherein the communication state of second layer includes information in accordance with a signal transmitted from the base station to the communication device to maintain communication between the communication device and the base station.

16. The communication device of claim 1,
wherein the communication device includes a mobile communication terminal.

17. The communication device of claim 1,
wherein the protocol in the first layer includes a transmission control protocol.

18. A communication method comprising:
setting, via a communication device, a retransmission determination time for a packet complying with a protocol of a first layer based on a communication state of a second layer that is lower than the first layer.

19. A computer-readable recording medium having stored therein a program, which when executed by circuitry of a system, causes the system to:
set a retransmission determination time for a packet complying with a protocol of a first layer based on a communication state of a second layer that is lower than the first layer.

20. A communication system comprising:
a first communication device; and
a second communication device configured to set a retransmission determination time for a packet complying with a protocol of a first layer and to be received by the first communication device, based on a communication state of a second layer that is lower than the first layer.
